(19) United States
(12) Patent Application Publication
(10) Pub. No.: US 2024/0226984 A1
(43) Pub. Date: Jul. 11, 2024

(54) Progressive Press Metal Mold

(71) Applicant: Kabushiki Kaisha F.C.C., Hamamatsu-shi (JP)

(72) Inventors: Michiharu YONEZAWA, Hamamatsu-shi (JP); Susumu ITO, Hamamatsu-shi (JP); Riaki IIDA, Hamamatsu-shi (JP)

(21) Appl. No.: 18/613,212

(22) Filed: Mar. 22, 2024

Related U.S. Application Data
(63) Continuation of application No. PCT/JP2022/038649, filed on Oct. 17, 2022.

(30) Foreign Application Priority Data
Oct. 19, 2021 (JP) 2021-171249

(51) Int. Cl. B21D 22/20

(52) U.S. Cl. CPC B21D 22/20

(57) ABSTRACT

A progressive press metal mold has a lower mold 1, with a die having a plurality of die holes Da, and an upper mold 2, with punches P corresponding to the respective die holes Da, where the punches P and the corresponding die holes Da form a plurality of processing stages S. A belt-shaped metal material W is transported sequentially to perform predetermined pressing on the belt-shaped metal material W with the punches P and the die holes Da in the respective processing stages S. Electromagnets 7 are configured to attract, by magnetic force, the belt-shaped metal material W to be transported to the specific processing stage Sc.

### CROSS-REFERENCE TO RELATED APPLICATIONS

This application is a continuation of International Application No. PCT/JP2022/038649, filed Oct. 17, 2022, which claims priority to Japanese Application No. 2021-171249, Oct. 19, 2021. The disclosures of the above applications are incorporating herein by reference.

### FIELD

The present disclosure relates to a progressive press metal mold, with a plurality of processing stages, where a belt-shaped metal material is transported sequentially to perform predetermined pressing on the belt-shaped metal material with a punch and a die hole in each processing stage.

### BACKGROUND

For example, as disclosed in Japanese Unexamined Patent Application Publication No. 2003-200296, an existing progressive press metal mold has a lower mold and an upper mold. The lower mold includes a plurality of dies with respective die holes corresponding to shapes formed by pressing. The upper mold includes punches corresponding to the respective die holes. The upper mold is capable of approaching and moving away from the lower mold. The punches and the corresponding die holes form a plurality of processing stages where a belt-shaped metal material (long thin original metal sheet) is transported sequentially to perform predetermined pressing on the belt-shaped metal material with the punch and the die hole in each processing stage.

In addition, a plurality of lifters are disposed on the lower mold of the existing progressive press metal mold. Thus, the existing progressive press metal mold is formed such that the belt-shaped metal material can be transported sequentially to the plurality of processing stages while being held up at a predetermined distance from a surface of each die. The lifters are each formed by a component urged upward by a spring. They are configured to be pressed downward against the urging force of the spring when the upper mold descends during pressing. Also, they are configured to hold up the belt-shaped metal material at the predetermined distance from the surface of each die by ascending due to the urging force of the spring when the upper mold ascends after pressing.

### SUMMARY

However, in the related art, for example, when sheet materials formed by punching in a specific processing stage are stacked and adhered to each other to form a rotor or a stator of a motor, an adhesive or other substances has to be applied, in a processing stage before the specific processing stage, to parts where the sheet materials are to be stacked. In this case, when lifters are disposed in the specific processing stage, the adhesive or other substances adheres to the lifters. Thus, it may not be possible to satisfactorily transport the belt-shaped metal material.

On the other hand, when no lifters are disposed in the specific processing stage, the belt-shaped metal material, to be transported to the specific processing stage, slides on the surface of the die and is bent by being caught by, for example, an opening edge portion of the die hole formed in the die. Thus, it may be difficult to satisfactorily transport the belt-shaped metal material. In particular, in the final processing stage, the belt-shaped metal material is in a state of being greatly reduced in rigidity and is greatly bent by being caught by, for example, the opening edge portion of the die hole. It is considered that examples of the reason why it is not possible to dispose lifter components in the specific processing stage include various reasons such as the layout of the metal mold and the quality of the belt-shaped metal material in addition to application of an adhesive.

The present disclosure provides a progressive press metal mold where it is possible to always satisfactorily transport a belt-shaped metal material to a specific processing stage regardless of the presence or absence of lifter components.

According to the disclosure, a progressive press metal mold comprises a lower mold, with a die having a plurality of die holes corresponding to shapes formed by pressing, and an upper mold, with punches corresponding to the respective die holes. The upper mold is capable of approaching and moving away from the lower mold. The punches and the corresponding die holes form a plurality of processing stages where a belt-shaped metal material is transported sequentially to perform predetermined pressing on the belt-shaped metal material with the punches and the die holes in the respective processing stages. A magnetic element, at least disposed on the upper mold in a specific processing stage, is configured to attract, by magnetic force, the belt-shaped metal material to be transported to the specific processing stage.

According to the disclosure, the magnetic element means is formed by an electromagnet. It generates magnetic force, when energized, that attracts, by the magnetic force, the belt-shaped metal material by being energized at a predetermined timing.

According to the disclosure, a pressing step, causing the upper mold to approach the lower mold, presses the belt-shaped metal material with the punches and the die holes in the processing stages. A transporting step causes the upper mold to move away from the lower mold to repeatedly transport the belt-shaped metal material sequentially to the subsequent processing stages. The magnetic element attracts the belt-shaped metal material, to be transported to the specific processing stage, by energizing only during the transporting step.

According to the disclosure, the specific processing stage, a plurality of sheet materials, punched from the belt-shaped metal material, is stacked to form an integrated multilayer component. In a processing stage before the specific processing stage, the predetermined pressing is performed. An adhesive is applied to parts where the sheet materials are stacked in the specific processing stage.

According to the disclosure, a lifter component is disposed on the lower mold. The lifter component holds up the belt-shaped metal material at a predetermined distance from a surface of the die in a process of transporting the belt-shaped metal material sequentially to the plurality of processing stages. The lifter component is not disposed in the specific processing stage.

According to the disclosure, the multilayer component formed in the specific processing stage is a rotor or a stator of a motor.

According to the disclosure, the progressive press metal mold includes the magnetic element, at least disposed on the upper mold, in the specific processing stage. The magnetic element is configured to attract, by magnetic force, the belt-shaped metal material to be transported to the specific processing stage. Thus, it is possible to always satisfactorily transport the belt-shaped metal material to the specific processing stage, regardless of the presence or absence of the lifter component.

According to the disclosure, the magnetic element is an electromagnet that generates magnetic force when energized and attracts, by the magnetic force, the belt-shaped metal material by being energized at a predetermined timing. Thus, it is possible to generate magnetic force that attracts the belt-shaped metal material only when necessary. Thus, it avoids magnetizing the lower mold and the die more than necessary.

According to the disclosure, the magnetic element means attracts the belt-shaped metal material, to be transported to the specific processing stage, when energized only during the transporting step. Thus, it is possible to avoid magnetizing the lower mold and the die more than necessary. Also, it is possible to accurately press the belt-shaped metal material by stop attracting the belt-shaped metal material during the pressing step.

According to the disclosure, in the specific processing stage, a plurality of sheet materials punched from the belt-shaped metal material is stacked to form an integrated multilayer component. In the processing stage, before the specific processing stage, the predetermined pressing is performed. The adhesive is applied to parts where the sheet materials are to be stacked in the specific processing stage. Thus, it is possible to adhere the sheet materials adjacent to each other by using the adhesive simultaneously with stacking of the sheet materials in the specific processing stage.

According to the disclosure, the lifter component is disposed on the lower mold. It holds up the belt-shaped metal material at the predetermined distance from the surface of the die in the process of transporting the belt-shaped metal material sequentially to the plurality of processing stages. The lifter component is not disposed in the specific processing stage. Thus, it is possible to prevent hindrance to transportation of the belt-shaped metal material caused by adhesion of the adhesive to the lifter component.

According to the disclosure, the multilayer component formed in the specific processing stage is a rotor or a stator of a motor. Thus, it is possible to smoothly form a rotor or a stator of a motor formed by stacking a plurality of sheet materials and by integrating the sheet materials by using an adhesive.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a general side view illustrating a progressive press metal mold according to the disclosure.

FIG. 2 is a plan view and a side view illustrating a lower mold of the progressive press metal mold.

FIG. 3 is a perspective view illustrating the lower mold of the progressive press metal mold.

FIG. 4 is a plan view and a side view illustrating an upper mold of the progressive press metal mold.

FIG. 5 is a perspective view of the upper mold of the progressive press metal mold.

FIG. 6 is a perspective view of guide components of the progressive press metal mold.

FIG. 7 is a sectional view of a lifter component of the progressive press metal mold.

FIG. 8 is a perspective view of a stator manufactured by using the progressive press metal mold.

### DETAILED DESCRIPTION

An embodiment of the present disclosure will be described in detail below with reference to the drawings.

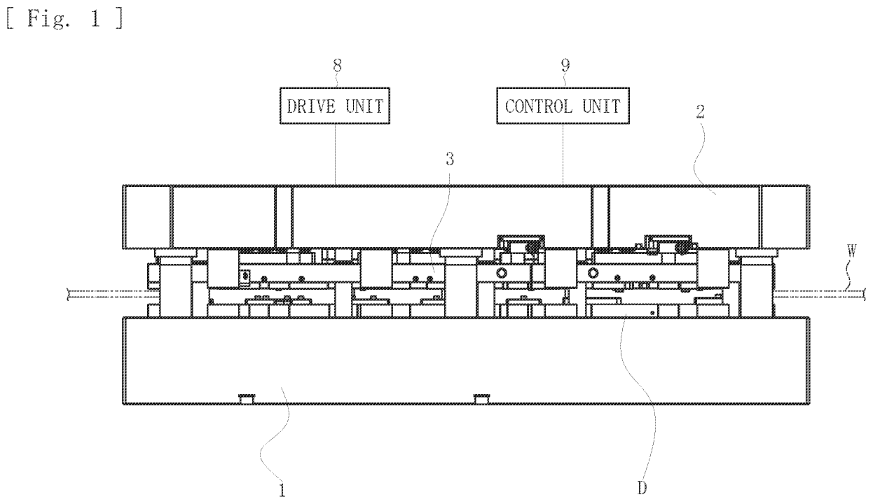

A progressive press metal mold according to the present embodiment has a plurality of processing stages where a belt-shaped metal material is transported sequentially to perform predetermined pressing on the belt-shaped metal material with a punch and a die hole in each processing stage. As illustrated in FIGS. 1 to 5, the progressive press metal mold is formed by a lower mold 1, an upper mold 2, a drive unit 8, that causes the upper mold 2 to ascend and descend repeatedly, and a control unit 9, that includes a microcomputer that controls the timing of energizing electromagnets 7.

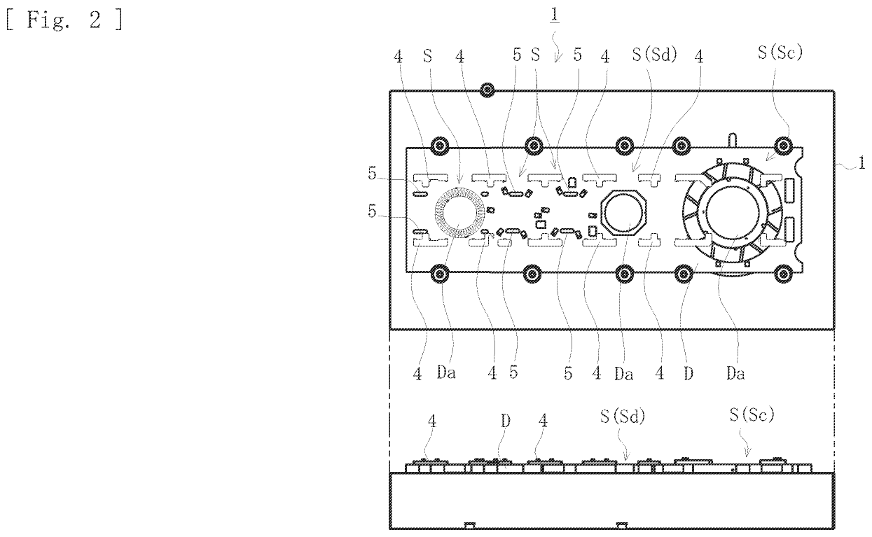

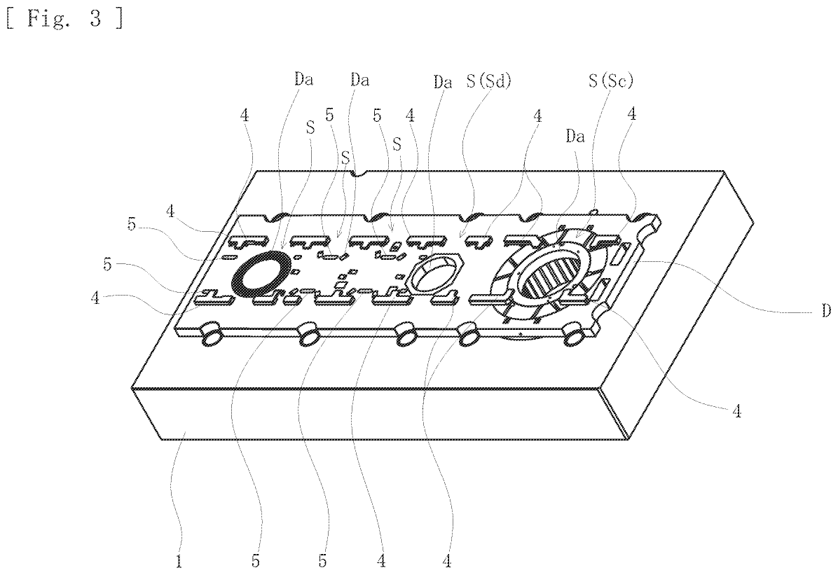

The lower mold 1 is fixed to a floor surface. As illustrated in FIGS. 2 and 3, the lower mold 1 is formed by a die D with a plurality of die holes Da corresponding to shapes formed by pressing. In addition, a belt-shaped metal material W (coil material) is held in a wound state in the vicinity of the lower mold 1. It is transported to the lower mold 1 by a feeder (not illustrated). The leftover part of the belt-shaped metal material W, subjected to predetermined pressing by the lower mold 1, is transported out by the feeder (not illustrated).

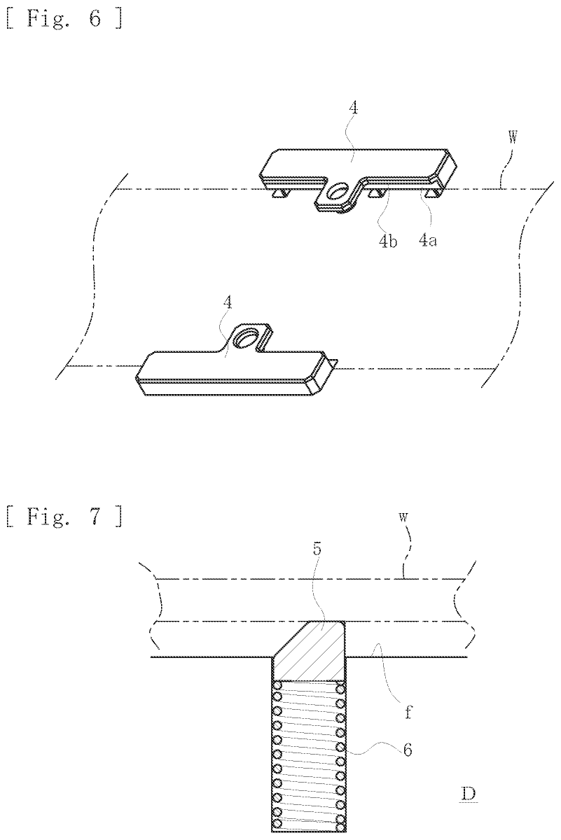

In addition, as illustrated in FIGS. 2 and 3, a plurality of guide components 4 is attached to the die D formed on the lower mold 1. The plurality of guide components 4 is arranged in the direction where the belt-shaped metal material W extends. Thus, this enables positioning of the moving belt-shaped metal material W in the width direction. That is, as illustrated in FIG. 6, the guide components 4 are disposed so as to be located on respective sides of the belt-shaped metal material W moving on the lower mold 1. The positioning of the belt-shaped metal material W in the width direction is performed by using side walls 4a of the guide components 4. In addition, upward movement of the belt-shaped metal material W is restricted by using upper walls 4b of the guide components 4.

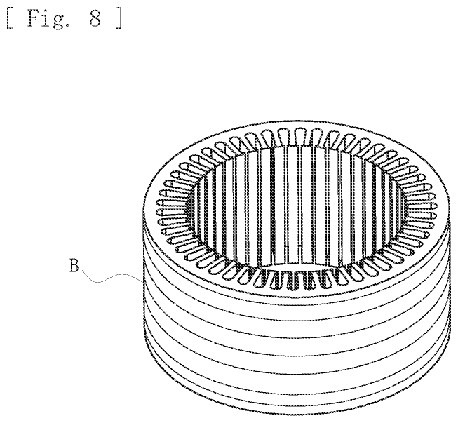

Furthermore, as illustrated in FIGS. 2 and 3, a plurality of lifter components 5 is attached to the die D formed on the lower mold 1. The plurality of lifter components 5 is arranged in the direction where the belt-shaped metal material W extends. Thus, this enables the belt-shaped metal material W to be held up at a predetermined distance from a surface f of the die D in a process of transporting the belt-shaped metal material W sequentially to a plurality of processing stages S as illustrated in FIG. 7.

Specifically, the lifter components 5 are each urged upward by an urging component 6 formed by a coil spring. The lifter components 5 are configured to be pressed downward against the urging force of the urging component 6 when the upper mold 2 descends during pressing. Also, they are configured to hold up the belt-shaped metal material W at the predetermined distance from the surface f of the die D by ascending to the position illustrated in FIG. 7. This is due to the urging force of the urging component 6 when the upper mold 2 ascends after pressing. Then, the belt-shaped metal material W slides and moves along tip surfaces of the lifter components 5 in the sequentially transporting process.

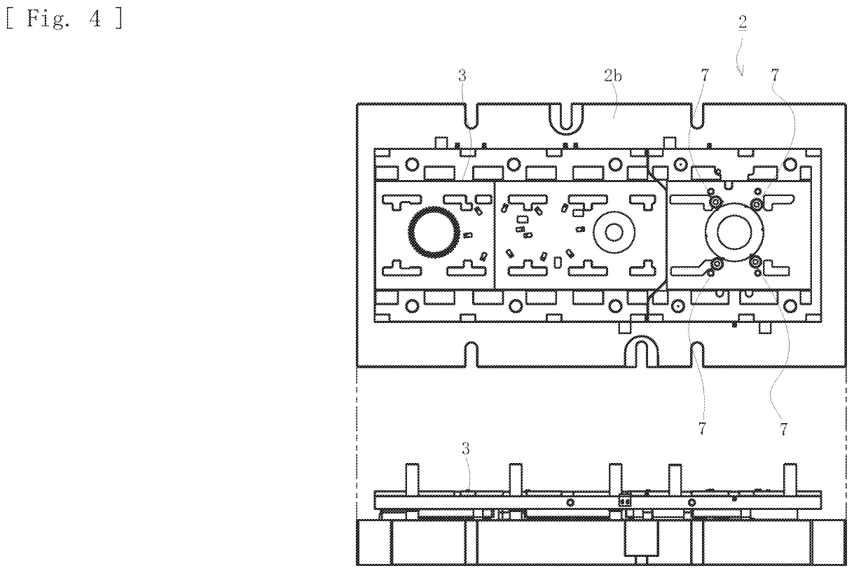

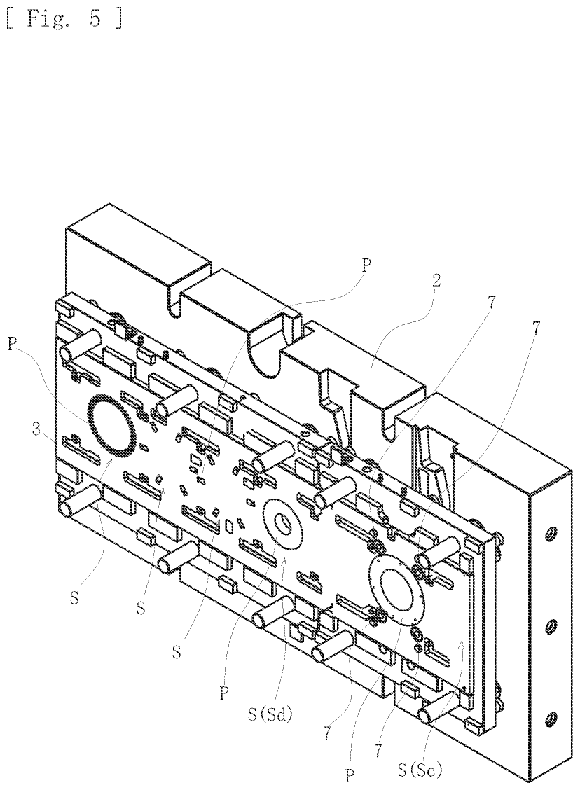

The upper mold 2 is disposed above the lower mold 1. As illustrated in FIGS. 4 and 5, the upper mold 2 includes punches P corresponding to the respective die holes Da. The upper mold 2 is capable of approaching and moving away from the lower mold 1 by being driven by the drive unit 8. That is, when the upper mold 2 descends and approaches the lower mold 1, the punches P are configured to be inserted into the corresponding die holes Da to perform pressing (punching in the present embodiment) on the corresponding parts of the belt-shaped metal material W.

In addition, a stripper 3, which covers and protects the punches P, is attached to the surface, facing the lower mold 1, of the upper mold 2. When the upper mold 2 approaches the lower mold 1, by being driven by the drive unit 8, the punches P are capable of inserting into the respective die holes Da by projecting from the stripper 3.

In this manner, the progressive press metal mold according to the present embodiment includes the plurality of processing stages S, that are formed by the punches P and the corresponding die holes Da. The belt-shaped metal material W is transported sequentially to perform the predetermined pressing (punching) on the belt-shaped metal material W with the punch P and the die hole Da in each processing stage S. That is, the predetermined pressing is performed, each time the upper mold 2 approaches the lower mold 1, on the belt-shaped metal material W simultaneously in the plurality of processing stages S formed by the lower mold 1 and the upper mold 2.

Thus, in the present embodiment, the final one of the plurality of processing stages S, formed by the lower mold 1 and the upper mold 2, is referred to as a specific processing stage Sc. The processing stage immediately before the specific processing stage Sc is referred to as a processing stage Sd.

Then, in the specific processing stage Sc, a plurality of sheet materials punched from the belt-shaped metal material W are stacked to form an integrated multilayer component. In addition, in the processing stage before the specific processing stage Sc (in the present embodiment, the processing stage Sd immediately before the specific processing stage Sc), the predetermined pressing is performed. An adhesive is applied to parts where the sheet materials are to be stacked in the specific processing stage Sc.

That is, in the processing stage Sd, the adhesive is applied in addition to the predetermined pressing. Subsequently, in the specific processing stage Sc, the parts where the adhesive is applied are subjected to punching to form sheet materials each having a predetermined shape. A plurality of the sheet materials, formed in this manner, is stacked. Thus, it is possible to form a multilayer component integrated by using the adhesive. In the present embodiment, as illustrated in FIG. 8, the multilayer component formed in the specific processing stage Sc is a stator B (multilayer stator) of a motor.

Here, the progressive press metal mold according to the present embodiment includes the electromagnets 7, that are at least disposed on the upper mold 2 in the specific processing stage Sc. They serve as a magnetic element attracting, by magnetic force, the belt-shaped metal material W to be transported to the specific processing stage Sc. As illustrated in FIGS. 4 and 5, the electromagnets 7 are disposed on the upper mold 2 (specifically, the stripper 3 attached to the upper mold 2) and generate magnetic force when energized. A plurality of, in the present embodiment, four circumferentially arranged, electromagnets 7 is attached to the periphery of the punch P in the specific processing stage Sc.

In addition, the electromagnets 7 are electrically connected to the control unit 9 and can be energized at a predetermined timing in synchronization with driving of the drive unit 8. Specifically, in the progressive press metal mold according to the present embodiment, a pressing step and transporting step are repeatedly performed The pressing step causes the upper mold 2 to approach the lower mold 1 by being driven by the drive unit 8 to press the belt-shaped metal material W with the punches P and the die holes Da in the processing stages S. The transporting step causes the upper mold 2 to move away from the lower mold 1 by being driven by the drive unit 8 to transport the belt-shaped metal material W sequentially to the subsequent processing stages S. In addition, the electromagnets 7 attract the belt-shaped metal material W to be transported to the specific processing stage Sc by being energized only during the transporting step.

In addition, in the progressive press metal mold according to the present embodiment, the lifter components 5 are not disposed in the specific processing stage Sc. That is, in a process of moving the belt-shaped metal material W in the processing stages S other than the specific processing stage Sc, the belt-shaped metal material W slides on the lifter components 5 and is transported sequentially while being held up at the predetermined distance from the surface f of the die D. In addition, in the specific processing stage Sc, which is the final processing stage, the belt-shaped metal material W is attracted up by the magnetic force generated by the electromagnets 7 and is thus transported while being held up at the predetermined distance from the surface f of the die D without the lifter components 5.

Accordingly, in a process of transporting the belt-shaped metal material W where the adhesive is applied in the processing stage Sd to the specific processing stage Sc and a process of performing the predetermined pressing (punching) on the belt-shaped metal material W in the specific processing stage Sc, it is possible to hold the belt-shaped metal material W at a position above the surface f of the die D by attraction of the magnetic force of the electromagnets 7 instead of the lifter components 5. Thus, it is possible to prevent the adhesive from adhering to the lifter components 5.

According to the present embodiment, the progressive press metal mold includes the electromagnets 7 that are at least disposed on the upper mold 2 in the specific processing stage Sc. They serve as a magnetic element attracting, by magnetic force, the belt-shaped metal material W to be transported to the specific processing stage Sc. Thus, it is possible to always satisfactorily transport the belt-shaped metal material W to the specific processing stage Sc regardless of the presence or absence of the lifter components 5. In particular, since the specific processing stage Sc is the final processing stage, the belt-shaped metal material W is most greatly reduced in rigidity and is easily bent without the lifter components 5. Accordingly, the belt-shaped metal material W can be transported effectively and certainly by being attracted up by the magnetic force generated by the electromagnets 7 in the specific processing stage Sc.

In addition, the magnetic elements, according to the present embodiment, are formed by the electromagnets 7, that generate magnetic force when energized. They attract, by the magnetic force, the belt-shaped metal material W, when energized, at a predetermined timing. Thus, it is possible to generate magnetic force that attracts the belt-shaped metal material W only when necessary and avoids magnetizing the lower mold 1 and the die D more than necessary. In particular, the magnetic elements according to the present embodiment attracts the belt-shaped metal material W to be transported to the specific processing stage Sc, when energized, only during the transporting step. Thus, it is possible to avoid magnetizing the lower mold 1 and the die D more than necessary and to accurately press the belt-shaped metal material W by stop attracting the belt-shaped metal material W during the pressing step.

Furthermore, in the specific processing stage Sc, a plurality of sheet materials punched from the belt-shaped metal material W are stacked to form an integrated multilayer component. In addition, in the processing stage Sd before (in the present embodiment, immediately before) the specific processing stage Sc, the predetermined pressing is performed. An adhesive is applied to parts where the sheet materials are to be stacked in the specific processing stage Sc. Thus, it is possible to adhere the sheet materials adjacent to each other by using the adhesive simultaneously with stacking of the sheet materials in the specific processing stage Sc.

Furthermore, the lifter components 5 are disposed on the lower mold 1. They hold up the belt-shaped metal material W at the predetermined distance from the surface f of the die D in the process of transporting the belt-shaped metal material W sequentially to the plurality of processing stages S. In addition, the lifter components 5 are not disposed in the specific processing stage Sc. Thus, it is possible to prevent hindrance to transportation of the belt-shaped metal material W caused by adhesion of an adhesive to the lifter components 5.

In addition, the multilayer component formed in the specific processing stage Sc is the stator B of the motor. Thus, it is possible to smoothly form the stator B of the motor formed by stacking a plurality of sheet materials and by integrating the sheet materials by using an adhesive. In addition, the multilayer component formed in the specific processing stage Sc may be a rotor of a motor. In this case, it is possible to smoothly form a rotor of a motor formed by stacking a plurality of sheet materials and by integrating the sheet materials by using an adhesive. The multilayer component formed in the specific processing stage Sc may be a different multilayer component. It may be premised that the multilayer component formed in the specific processing stage Sc is integrated by, for example, caulking in addition to an adhesive.

In addition, the progressive press metal mold according to the present embodiment sequentially forms the stator B of the motor. However, the progressive press metal mold may be formed such that a progressive press metal mold that forms a rotor of the motor and a progressive press metal mold that forms the stator B are arranged in series or such that the progressive press metal mold that forms the rotor and the progressive press metal mold that forms the stator B are arranged in parallel.

The present embodiment has been described above, but the present disclosure is not limited. For example, the magnetic elements may be permanent magnets instead of the electromagnets 7. In addition, the magnetic elements according to the present embodiment, attract the belt-shaped metal material W to be transported to the specific processing stage Sc by being energized only during the transporting step. However, the magnetic elements may attract the belt-shaped metal material W to be transported to the specific processing stage Sc by being energized during both the pressing step and the transporting step.

In addition, in the present embodiment, the magnetic elements are disposed only on the upper mold 2 in the specific processing stage Sc. However, the magnetic elements may be disposed in other processing stages in addition to the specific processing stage Sc. In the present embodiment, the lifter components 5 are not disposed in the specific processing stage Sc. In addition, in the present embodiment, the magnetic elements are disposed only on the upper mold 2 in the specific processing stage Sc. However, the magnetic elements may be disposed in other processing stages in addition to the specific processing stage Sc. In the present embodiment, the lifter components 5 are not disposed in the specific processing stage Sc, and the lifter components 5 are disposed in other parts. However, the lifter components 5 do not have to be disposed in the other parts and may be disposed not only at the edge portions of the metal material W but also in the vicinity of the central portion of the metal material W. In addition, in the present embodiment, the punches P and the die holes Da are disposed in a row in the direction where the metal material W is transported. However, the punches P and the die holes Da may be disposed in two or more rows in the direction where the metal material W is transported to punch a plurality of products simultaneously.

The present disclosure is also applicable to, for example, progressive press metal molds with different external shapes or with other added functions as long as the progressive press metal molds each include magnetic elements that are at least disposed on an upper mold in a specific processing stage and that attract, by magnetic force, a belt-shaped metal material to be transported to the specific processing stage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A progressive press metal mold comprising:
a lower mold including a die having a plurality of die holes corresponding to shapes formed by pressing;
an upper mold including punches corresponding to the respective die holes, the upper mold capable of approaching and moving away from the lower mold, the punches and the corresponding die holes forming a plurality of processing stages where a belt-shaped metal material is transported sequentially to perform predetermined pressing on the belt-shaped metal material with the punches and the die holes in the respective processing stages; and
a magnetic element at least disposed on the upper mold in a specific processing stage, the magnetic element configured to attract, by magnetic force, the belt-shaped metal material to be transported to the specific processing stage.

2. The progressive press metal mold according to claim 1, wherein the magnetic element is formed by an electromagnet that generates magnetic force, when energized, and attracts, by the magnetic force, the belt-shaped metal material by being energized at a predetermined timing.

3. The progressive press metal mold according to claim 2, wherein
a pressing step, causing the upper mold to approach the lower mold, to press the belt-shaped metal material with the punches and the die holes in the processing stages and
a transporting step, causing the upper mold to move away from the lower mold, to transport the belt-shaped metal material sequentially to the subsequent processing stages are performed repeatedly, and
the magnetic element attracts the belt-shaped metal material to be transported to the specific processing stage by being energized only during the transporting step.

4. The progressive press metal mold according to claim 1, wherein
in the specific processing stage, a plurality of sheet materials punched from the belt-shaped metal material is stacked to form an integrated multilayer component, and
in a processing stage before the specific processing stage, the predetermined pressing is performed, and an adhesive is applied to parts where the sheet materials are to be stacked in the specific processing stage.

5. The progressive press metal mold according to claim 4, wherein
a lifter component, that holds up the belt-shaped metal material at a predetermined distance from a surface of the die in a process of transporting the belt-shaped metal material sequentially to the plurality of processing stages, is disposed on the lower mold, and
the lifter component is not disposed in the specific processing stage.

6. The progressive press metal mold according to claim 4, wherein the multilayer component formed in the specific processing stage is a rotor or a stator of a motor.
